(19) United States
(12) Patent Application Publication
(10) Pub. No.: US 2006/0173852 A1
(43) Pub. Date: Aug. 3, 2006

(54) Apparatus and method for highlighting discrepancies between query performance estimates and actual query performance

(75) Inventors: Robert Joseph Bestgen, Dodge Center, MN (US); Shantan Kethireddy, Rochester, MN (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/047,533

(22) Filed: Jan. 31, 2005

(51) Int. Cl. G06F 17/30; G06F 7/00

(52) U.S. Cl. 707/10

(57) ABSTRACT

A visual query explain mechanism displays a query to the user in a graphical tree format. A user may execute a query, and the actual performance from executing the query is imported into the visual query explain mechanism. The visual query explain mechanism adds the actual performance to the nodes in the query tree, and compares the actual performance to the estimates of performance that were generated prior to executing the query. The visual query explain mechanism then looks at a predefined threshold value, and determines whether actual performance exceeds the estimated performance by the predefined threshold value. If so, the corresponding node in the query graph is highlighted in some way, thereby providing a visual indication to the user of problem areas in the query.

### BACKGROUND OF THE INVENTION

1. Technical Field

This invention generally relates to computer systems, and more specifically relates to apparatus and methods for improving the run-time performance of database queries.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records are returned as the query result. Some tools are available that help users and programmers to optimize a query by showing a graphical representation of the query. One such tool is Visual Explain available from IBM Corporation. In Visual Explain, a query is represented in a graphical tree format. Using Visual Explain, a user can identify and analyze database performance problems using estimates of query performance. Using the “run and explain” feature in Visual Explain, the user can run a query, and manually compare the run-time performance of the query to the estimated performance of the query. When the run-time performance of a query is different than the estimated performance of the query, the user must take manual steps to generate new queries that correspond to sub-parts of the query in an attempt to localize the performance problem to a specific part of the query. This process of manually rewriting sub-parts of the query is very time-intensive and requires considerable expertise. Without a way to eliminate the manual rewriting of query sub-parts into independent form and executing these queries in a manual trial-and-error manner, the database industry will continue to suffer from inefficient ways to track down problems with database query implementations.

### DISCLOSURE OF INVENTION

According to the preferred embodiments, a visual query explain mechanism displays a query to the user in a graphical tree format. A user may execute a query, and the actual performance from executing the query is imported into the visual query explain mechanism. The visual query explain mechanism adds the actual performance to the nodes in the query tree, and compares the actual performance to the estimates of performance that were generated prior to executing the query. The visual query explain mechanism then looks at a predefined threshold value, and determines whether actual performance exceeds the estimated performance by the predefined threshold value. If so, the corresponding node in the query graph is highlighted in some way, thereby providing a visual indication to the user of problem areas in the query.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a sample display of a prior art Visual Explain tool for analyzing database queries;

FIG. 3 is a flow diagram of a prior art method for analyzing database queries;

FIG. 4 is a sample display of a Visual Explain tool in accordance with the preferred embodiments;

FIG. 5 is a flow diagram of a method for analyzing database queries in accordance with the preferred embodiments;

FIG. 6 is a flow diagram of a method for analyzing a database query as it is executing; and

FIG. 7 is a sample display window showing a user interface for setting a discrepancy threshold value in accordance with the preferred embodiments.

### BEST MODE FOR CARRYING OUT THE INVENTION

### 1.0 Overview

The present invention relates to the analysis of database queries. For those not familiar with databases or queries, this Overview section will provide background information that will help to understand the present invention.

### Known Databases and Database Queries

There are many different types of databases known in the art. The most common is known as a relational database (RDB), which organizes data in tables that have rows that represent individual entries or records in the database, and columns that define what is stored in each entry or record.

To be useful, the data stored in databases must be able to be efficiently retrieved. The most common way to retrieve data from a database is to generate a database query. A database query is an expression that is evaluated by a database manager. The expression may contain one or more predicate expressions that are used to retrieve data from a database. For example, lets assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix.

One popular way to define a query uses Structured Query Language (SQL). SQL defines a syntax for generating and processing queries that is independent of the actual structure and format of the database. Note that an SQL query is expressed in terms of columns defined on one or more database tables. Information about the internal storage of the data is not required as long as the query is written in terms of expressions that relate to values in columns from tables.

### Known Query Analysis Tool

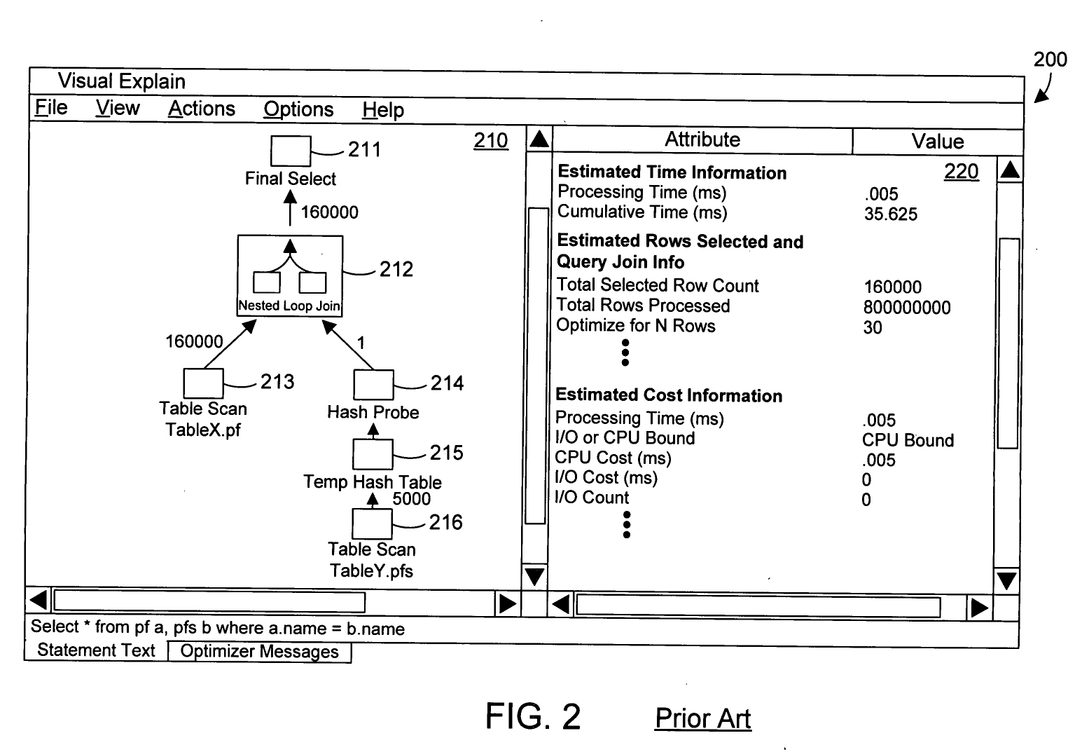

As stated in the Background section above, IBM Corporation has developed a tool known as Visual Explain that presents a graphical representation of a query, and allows a user to analyze problem queries that do not run as well as predicted. The Visual Explain tool generates estimates of query performance based on estimated performance for the different nodes in the graphical representation of the query. FIG. 2 shows a sample display for the known Visual Explain tool. This display 200 includes a query tree window 210 and a text information window 220. The query tree window 210 presents a graphical representation of a query that includes one or more nodes that may be connected with arcs, as shown in FIG. 2. For the specific query shown at the bottom of FIG. 2, namely:
select * from pf a, pfs b where a.name=b.name
the query tree is shown in query tree window 210 in FIG. 2. This query tree includes a final select node 211, a nested loop join node 212, a table scan node 213, a hash probe node 214, a temporary hash table node 215, and a table scan node 216. Each of these nodes represents an operation performed by the query optimizer when executing the query. The query tree thus shows one specific implementation for the query that was generated by the query optimizer according to known techniques. The arcs connecting nodes indicate the number of rows that are operated on by the node from which the arc originates. Thus, the table scan node 213 in FIG. 2 includes an arc that is marked with the value 160000, which means that this table scan corresponding to node 213 is estimated to access 160,000 rows each time it is performed. Likewise, the value 5000 on the arc between the table scan node 216 and the temporary hash table node 215 indicates that the table scan corresponding to node 216 is estimated to access 5,000 rows each time it is performed.

The text information window 220 includes text information for whatever node is currently selected in the query tree window 210. We see from FIG. 2 that the nested loop join node 212 has a box around it, indicating it has been selected by a user. As a result, the information in the text information window 220 includes text information pertaining to the nested loop join node 212. We see from the example text information in FIG. 2 that the estimated processing time for this node is 0.005 milliseconds (ms), with a cumulative time of 35.625 ms. The total selected row count is estimated at 160,000, and the total rows processed is estimated to be 800,000,000. There is also estimated cost information that specifies processing time in terms of time (milliseconds). For the example in FIG. 2, the processing time is estimated to be 0.005 ms. The text information also indicates that this query is CPU bound (rather than I/O bound), so the processing time of 0.005 ms is the same as the CPU cost of 0.005 ms. The text information window 220 may display many other items that are not shown in FIG. 2, as is known in the art.

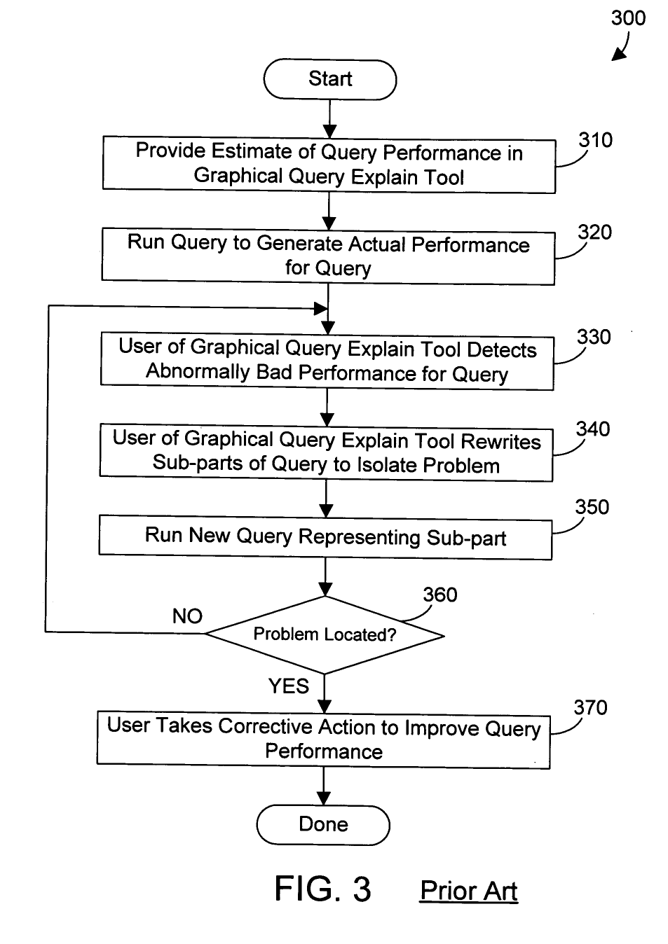

Referring now to FIG. 3, a prior art method 300 for analyzing database queries is shown. First, estimates are provided for the query performance in the graphical explain tool (step 310). These estimates are typically generated by the query optimizer that generated the specific query implementation displayed in query tree window 210. Next, the query is run to generate actual performance for the query (step 320). The user then manually compares the actual performance for the query with the estimated performance for the query, and detects when the actual performance is abnormally bad (step 330). Note that the estimated performance for the query is the estimated performance for the final select node 211 in FIG. 2. When the query is executed, the only information available to the user is the actual performance for the entire query, which is shown as an attribute of the final select node 211. If the actual performance is significantly worse than the estimated performance, the user must then perform a series of manual steps to try to locate the problem with the query. For example, for a complex query, the user may re-write sub-parts of the query (step 340) and execute them as separate queries (step 350) to see if the performance of each sub-part is as estimated. Because the actual performance is only available for the entire query, each sub-part must be reformulated into an independent query to allow comparing the actual performance for the independent query (representing the sub-part) with the estimated performance for the sub-part. If no problem is located (step 360=NO), steps 330, 340 and 350 are repeated. Note that steps 330 and 340 are manual processes performed by the user. In fact, step 340 of rewriting the query sub-parts into independent queries takes considerable time and skill to perform, and is prone to errors.

Using the manual iterative process shown in FIG. 3 in steps 330, 340, 350 and 360, if the user locates a problem (step 360=YES), the user may then take corrective action to improve the query performance (step 370). One known way to take corrective action is to use a statistics advisor and index advisor in Visual Explain to determine what corrective action would be helpful in improving performance for the query.

### 2.0 Description of the Preferred Embodiments

The present invention adds functionality to the known Visual Explain tool to automatically import actual performance for each query sub-part, and to highlight any problem nodes so the user can tell from a glance of the query tree which nodes have problems in actual performance compared to estimated performance. In addition, the Visual Explain tool may be invoked to explain a running query.

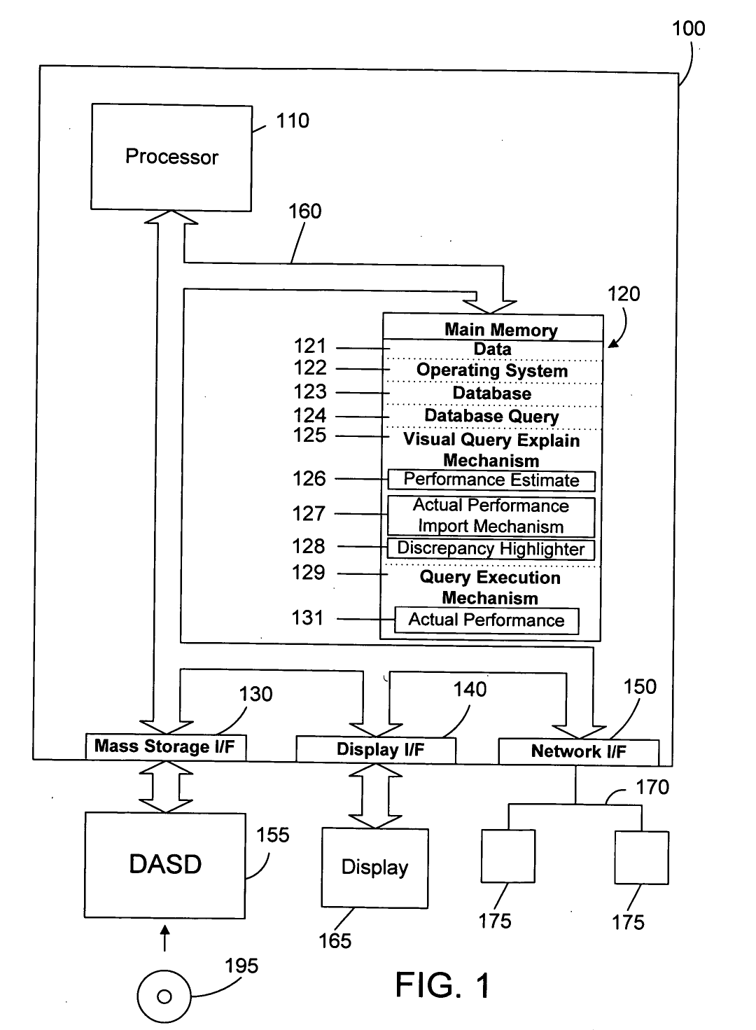

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a database 123, one or more database queries 124, a visual query explain mechanism 125, and a query execution mechanism 129. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Database 123 is any suitable database, whether currently known or developed in the future. Database 123 preferably includes one or more tables. Database query 124 is a query in a format compatible with the database 123 that allows retrieval of information stored in the database 123 that satisfies the database query 124. Visual query explain mechanism 125 is a tool that provides a graphical representation of a query in a graphical user interface that allows a user to more easily view attributes of the query and sub-parts of the query. The query execution mechanism 129 executes queries, and stores the actual performance 131 for a query.

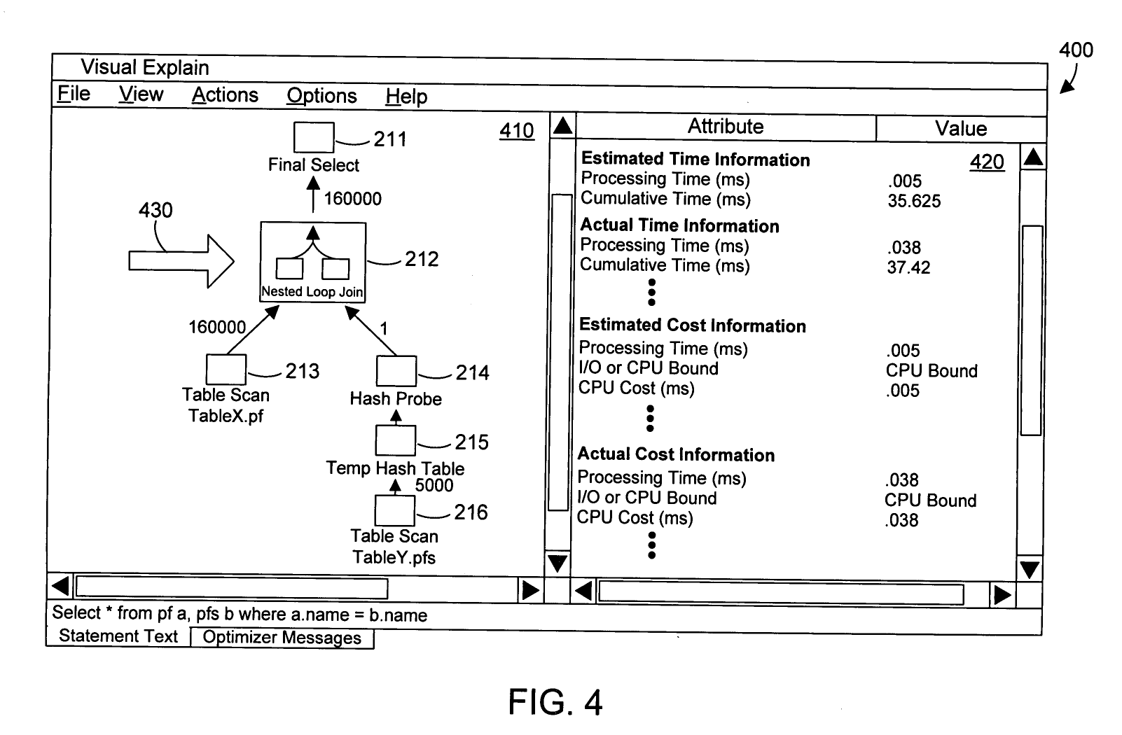

The visual query explain mechanism 125 includes one or more performance estimates 126, an actual performance import mechanism 127, and a discrepancy highlighter 128. The performance estimates 126 are preferably estimates based on row count, CPU cost, or processing time for the query and for sub-parts of the query, and may include estimates of all three. Of course, other performance estimates could also be used within the scope of the preferred embodiments. The actual performance import mechanism 127 imports the actual performance 131 for a query into the visual query explain mechanism 125. Once actual performance 131 for the query sub-parts are imported, they may be displayed as attributes of nodes in the query. In the preferred embodiments, actual performance 131 preferably includes actual performance for sub-parts of a query in addition to actual performance for the overall query, unlike the prior art which only provides actual performance for the overall query. The discrepancy highlighter 128 is used to highlight in the query tree one or more nodes that have actual performance that differs from the estimated performance by some predetermined threshold value. By highlighting the nodes in the query that exceed estimates by some specified threshold value, the user can take steps to implement the query in different ways to improve the performance of the query. The function of the visual query explain mechanism 125 and its discrepancy highlighter 128 is discussed in more detail below with reference to FIGS. 4-7.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, database query 124, visual query explain mechanism 125, and query execution mechanism 129 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

Referring now to FIG. 4, a sample display 400 represents the display of the visual query explain mechanism 125 shown in FIG. 1. Display 400 includes a query tree window 410 and a text information window 420. Query tree window 410 includes the same nodes shown in the prior art query tree window 210 in FIG. 2, namely: final select node 211, nested loop join node 212, table scan node 213, hash probe node 214, temporary hash table 215, and table scan 216.

The text information window 420 includes not only the estimated query performance, but also includes actual query performance. Thus, text information window 420 includes a section “Estimated Time Information” and a corresponding section “Actual Time Information”; and contains a section “Estimated Cost Information” and a corresponding section “Actual Cost Information”. The actual query performance information displayed in the text information window 420 is received from the query execution mechanism 129 in FIG. 1 via the actual performance import mechanism 127. The visual query explain mechanism 125 compares the estimated performance with the actual performance, and highlights any node in the query tree window 410 that has an actual performance that differs from the estimated performance by more than a specified threshold value. For the nested loop join node 212 in FIG. 4, we see from the text information window 420 that the estimated processing time for the node was 0.005 ms, while the actual processing time was 0.038 ms, over seven times the estimated processing time. If we assume, for example, that the threshold is set to a factor of five, the actual processing time of 0.038 ms exceeds the estimated processing time of 0.005 ms by more than the predetermined threshold value, so the visual query explain mechanism 125 highlights the nested loop join node 212 in the query tree window 410 in FIG. 4. The highlight shown in FIG. 4 is an arrow 430 that points to the node 212. This provides a visual indication that the nested loop join node 212 has an actual performance that exceeds the estimated performance by more than the predefined threshold value.

The arrow 430 highlight is shown in FIG. 4 as one suitable way to highlight a node in a query tree. One skilled in the art will recognize that many suitable ways exist to highlight part of a query tree, many of which are difficult to represent in a black-and-white drawing. For example, a node could be colored a different color, could have a box with a particular color put around it, could flash or blink, could move slightly back and forth or up and down. These are all examples of suitable highlights. The preferred embodiments expressly extend to any and all mechanisms and methods for visually highlighting (or indicating) a node or arc in a query tree, whether such highlighting mechanisms and methods are currently known or developed in the future.

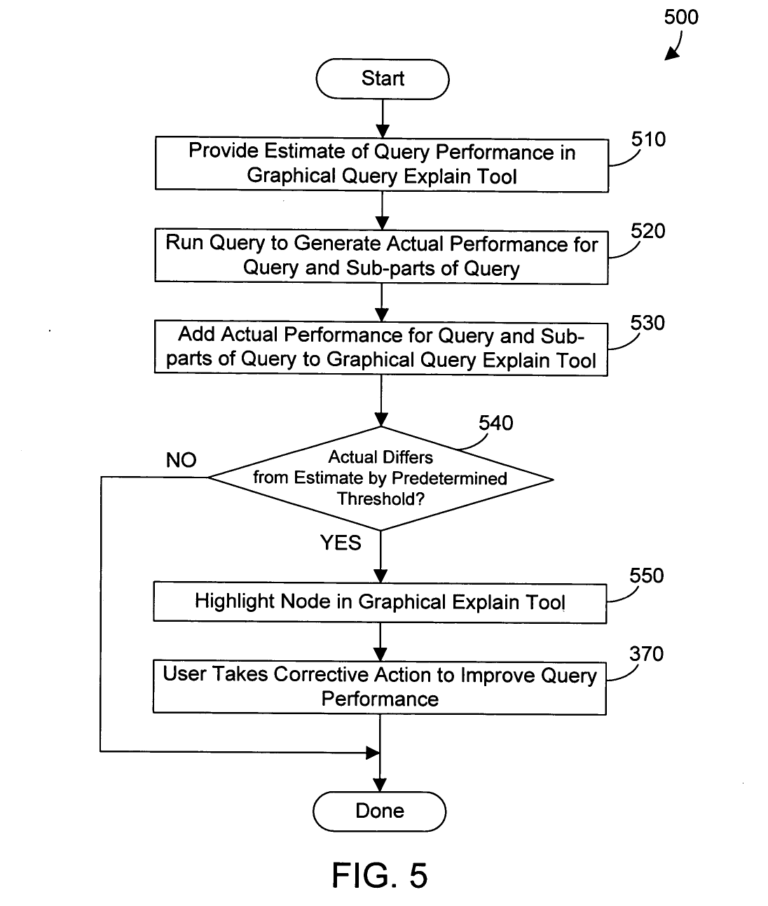

Referring now to FIG. 5, a method 500 in accordance with the preferred embodiments begins by providing an estimate of query performance in a graphical query explain tool (step 510). As in the prior art, the estimated query performance in step 510 is preferably generated by the query optimizer that generated the specific query implementation displayed in query tree window 410. The query is then run to generate actual performance for the query and for sub-parts of the query (step 520). One significant feature of step 520 in FIG. 5 compared to step 320 in prior art method 300 in FIG. 3 is the generation of actual performance for sub-parts of the query, which typically does not occur in the prior art method 300. The actual performance for the query and its sub-parts is then added to the graphical query explain tool (step 530). This is performed by the actual performance import mechanism 127 in FIG. 1, which imports the actual performance 131 from the query execution mechanism 129. The actual performance is then compared to the estimated performance. If the actual performance of a particular node differs from the estimated performance by some predetermined threshold value (step 540=YES), the corresponding node in the graphical explain tool is highlighted (step 550). This highlighting brings the user's attention to the node. The user may then take corrective action to improve performance of the query (step 370). Note that the corrective actions may be the same as in the prior art method 300 in FIG. 3. If the actual performance does not differ from the estimated performance by the predetermined threshold value (step 540=NO), the corresponding node is not highlighted, and method 500 is done. Note that steps 540, 550 and 370 in method 500 are preferably repeated for each node in the query tree window 410 that has an actual performance that differs from the estimated performance by the predetermined threshold value.

Significant features in method 500 in FIG. 5 when compared to prior art method 300 in FIG. 3 include the automatic importing of performance information for the sub-parts of the query, and the automatic highlighting of nodes that have an actual performance that differs from the expected performance by more than some predefined threshold value. This powerful combination of features allows automatically highlighting nodes in the query graph without the user having to rewrite and execute new queries that represent sub-parts of the original query (as shown in steps 340 and 350 in FIG. 3). The method of the preferred embodiments thus provides a powerful tool that helps a user to more quickly determine the problem spots with queries that do not run as well as expected.

In most real-world situations, a node in a query is considered problematic only if the actual performance for the node is worse than the estimated performance for the node by the predetermined threshold value. Note, however, that the preferred embodiments are not limited to highlighting nodes that perform worse than estimated, but may also highlight nodes that perform better than estimated. For example, the highlight could change depending on whether the actual performance for a node is better than estimated or worse than estimated. On one specific implementation, a node that is better than estimated could be highlighted in green, while a node that is worse than estimated could be colored in red. The preferred embodiments expressly extend to highlighting nodes whose actual performance differs from estimated performance by some predetermined threshold value, regardless of whether the actual performance is greater than or less than the estimated performance.

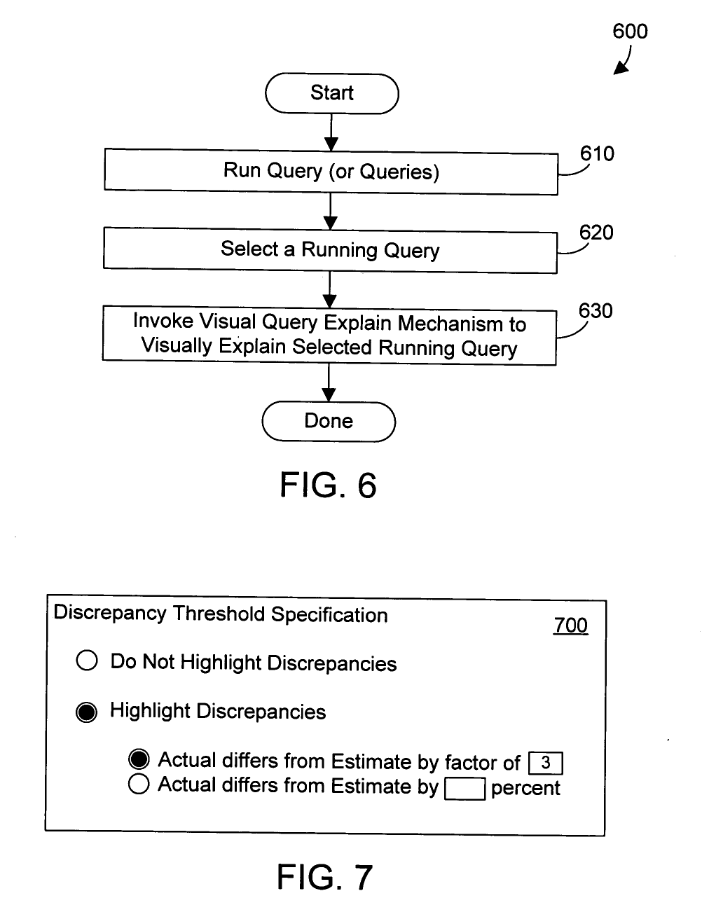

Referring now to FIG. 6, a method 600 in accordance with the preferred embodiments allows using the visual query explain mechanism 125 in FIG. 1 when a query is already running. One or more queries are run (or executed) (step 610). One of the running queries is selected (step 620). The visual query explain mechanism is then invoked to visually explain the selected running query (step 630). Method 600 is shown to simply illustrate one specific context for using the visual query explain mechanism of the preferred embodiments. The visual query explain mechanism may be used to explain queries that are not running, and also to explain queries that are running. The ability to explain queries that are currently running is now known in the art, and is an enhancement provided by the preferred embodiments.

A user interface window 700 is shown in FIG. 7 as one suitable way for a user to set the predetermined threshold value for highlighting a query sub-part in the query tree window 410. The “predetermined threshold value” referred to herein and in the claims is referred to in FIG. 7 as a “discrepancy threshold”. The user may select one of two mutually-exclusive radio buttons “Do Not Highlight Discrepancies” and “Highlight Discrepancies”. In FIG. 7, the radio button for “Highlight Discrepancies” is selected, which allows the user to now select one of the two radio buttons below that specify how the discrepancy threshold is computed. In this specific example, the user may specify the discrepancy threshold value as a factor of the estimated performance, or as a percentage of the estimated performance. In FIG. 7, the top radio button is selected, which allows a user to enter a numerical value in a box to specify a factor for the discrepancy threshold. In this case, the number three is entered in the box, which means the discrepancy threshold is set to a value of three times the estimated performance. Of course, many other ways and mathematical methods may be used to specify, compute, or derive a discrepancy threshold, and the preferred embodiments expressly extend to any suitable way, method or heuristic for specifying, computing or deriving a predetermined threshold value that may be used to compare actual query performance with estimated query performance.

The preferred embodiments are described herein as highlighting a node in a query tree if the actual performance differs from the estimated performance by more than some predetermined threshold value. Note, however, that this language does not imply any specific boundary for the threshold value. Thus, the threshold value may be specified, and the action of highlighting can be defined in terms of the actual performance being greater than the threshold value, greater than or equal to the threshold value, less than the threshold value, or less than or equal to the threshold value. In other words, the preferred embodiments extend to any suitable definition of threshold value and any suitable mathematical operator with respect to the threshold value.

Another variation that could be made within the scope of the preferred embodiments is the ability to specify multiple threshold values. For example, a default threshold value could be specified that would apply to all nodes that do not have a different explicitly-defined threshold value. In addition, each node may have it's own threshold value specified. While this may take more time for the user to setup, it also provides the user more flexibility in tracking down query performance problems.

The preferred embodiments provide a visual highlight in a graphical user interface that help a user to quickly identify portions of a query that have a performance that differs from estimated performance by a predefined threshold value. Actual performance for each query sub-part is imported from a query execution mechanism. The actual performance for each node is then compared against the estimated performance for each node. If the actual performance differs from the estimated performance by more than a predetermined threshold value, the node is highlighted in the graphical user interface. The user may then take appropriate action to improve the query implementation.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a query residing in the memory that references a database table; and
a visual query explain mechanism residing in the memory and executed by the at least one processor, the visual query explain mechanism providing a graphical representation of the query and highlighting at least one portion of the graphical representation to indicate an actual query performance that differs from an estimated query performance by a predetermined threshold value.

2. The apparatus of claim 1 wherein the graphical representation of the query includes a plurality of nodes that each represent a step in implementing the query.

3. The apparatus of claim 1 wherein the visual query explain mechanism comprises an actual performance import mechanism that imports actual query performance for the query and for at least one sub-part of the query.

4. The apparatus of claim 1 wherein the visual query explain mechanism may be invoked to analyze a running query.

5. The apparatus of claim 1 further comprising a user interface mechanism that allows a user to specify the predetermined threshold value.

6. The apparatus of claim 1 wherein the actual query performance comprises query performance for each of a plurality of sub-parts of the query.

7. The apparatus of claim 1 wherein the actual query performance and the estimated query performance may be specified in terms of row count, CPU time, and processing time.

8. A computer-implemented method for enhancing performance of a query that references a database table, the method comprising the steps of:
(A) displaying a graphical representation of the query that includes estimated performance for the query;
(B) determining actual performance for the query;
(C) comparing the actual performance for the query to the estimated performance for the query; and
(D) highlighting at least one portion of the graphical representation to indicate the actual performance differs from the estimated performance by a predetermined threshold value.

9. The method of claim 8 wherein the graphical representation of the query includes a plurality of nodes that each represent a step in implementing the query.

10. The method of claim 8 wherein step (B) comprises the step of importing the actual performance for the query and for at least one sub-part of the query.

11. The method of claim 8 wherein steps (C) and (D) are performed as the query executes.

12. The method of claim 8 further comprising the step of a user specifying the predetermined threshold value.

13. The method of claim 8 wherein the actual performance comprises performance for each of a plurality of sub-parts of the query.

14. The method of claim 8 wherein the actual performance and the estimated performance may be specified in terms of row count, CPU time, and processing time.

15. A program product comprising:
(A) a visual query explain mechanism that provides a graphical representation of a query to a database table and highlights at least one portion of the graphical representation to indicate an actual query performance that differs from an estimated query performance by a predetermined threshold value; and
(B) computer-readable signal bearing media bearing the visual query explain mechanism.

16. The program product of claim 15 wherein the computer-readable signal bearing media comprises recordable media.

17. The program product of claim 15 wherein the computer-readable signal bearing media comprises transmission media.

18. The program product of claim 15 wherein the graphical representation of the query includes a plurality of nodes that each represent a step in implementing the query.

19. The program product of claim 15 wherein the visual query explain mechanism comprises an actual performance import mechanism that imports actual query performance for the query and for at least one sub-part of the query.

20. The program product of claim 15 wherein the visual query explain mechanism may be invoked to analyze a running query.

21. The program product of claim 15 further comprising a user interface mechanism that allows a user to specify the predetermined threshold value.

22. The program product of claim 15 wherein the actual query performance comprises query performance for each of a plurality of sub-parts of the query.

23. The program product of claim 15 wherein the actual query performance and the estimated query performance may be specified in terms of row count, CPU time, and processing time.
